(19) United States
(12) Patent Application Publication
(10) Pub. No.: US 2016/0059172 A1
(43) Pub. Date: Mar. 3, 2016

(54) FILTER ELEMENT AND AIR CLEANER ASSEMBLY

(71) Applicant: CATERPILLAR INC., Peoria, IL (US)

(72) Inventors: MARK T. ALLOTT, Mapleton, IL (US); Timothy S. Finn, Peoria Heights, IL (US); Vincent P. Caliendo, Peoria, IL (US); Bobby J. Kinsey, JR., Washington, IL (US); Vicky S. Wright, Pekin, IL (US); Philip C. Spengler, Wahsington, IL (US)

(73) Assignee: CATERPILLAR INC., Peoria, IL (US)

(21) Appl. No.: 14/471,914

(22) Filed: Aug. 28, 2014

(51) Int. Cl. B01D 46/10; B01D 46/00

(52) U.S. Cl. CPC B01D 46/10; B01D 46/0005

(57) ABSTRACT

A filter element for an air cleaner assembly may include a first side member and a second side member opposite the first side member. The first and second side members may extend in a substantially longitudinal direction and substantially within respective first and second planes with an intermediate space therebetween. The filter element may further include filter media separating and extending between the first side member and the second side member in the intermediate space. The first and second side members and the filter media may have a perimeter cross-section substantially perpendicular to the longitudinal direction, and the filter element may further include a locating flange extending substantially around the perimeter cross-section and transverse to the longitudinal direction, wherein the locating flange does not lie within a single plane.

### TECHNICAL FIELD

The present disclosure relates to a filter element and an air cleaner assembly, and more particularly, to a filter element and an air cleaner assembly including the filter element.

### BACKGROUND

Many machines rely on air taken from the surroundings for operation. For example, internal combustion engines often rely on air to assist with combustion of fuel to develop power that may be used to perform work, such as propelling a vehicle and/or operating other devices associated with the vehicle. If particulates such as dust and dirt enter the internal combustion engine via the intake system, they may contaminate the oil and other parts of the engine, which may result in premature wear or damage to parts of the internal combustion engine. In order to prevent this potential premature wear or damage, air filtration devices may be provided to prevent entry of particulates into the internal combustion engine.

Air filtration devices may include filter media that captures particulates as the air passes through the air filtration device. With use, the filter media becomes laden with particulates, thereby increasing the pressure differential across the air filtration device and/or decreasing the efficiency of the engine. As a result, it may be necessary to either clean or replace the filter media.

Air filtration devices may have different filtration characteristics, such as, for example, different filtration capacities, different levels of effectiveness for capturing particulates larger than a predetermined size, and different projected service lives. Depending on circumstances associated with operation of the machine on which the air filtration device is installed, it may be desirable to use an air filtration device having different characteristics. For example, when a machine has been purchased by a first owner, it may be anticipated that it will be operated on a regular basis and for an extended period of time. It may be desirable under such circumstances to provide the machine with an air filtration device having a relatively long projected service life. This would result in less maintenance time associated with cleaning or replacing the air filtration device. In contrast, a subsequent purchaser of the previously owned machine may not anticipate using the machine on as consistent a basis as the first owner. Under such circumstances, it may be desirable to provide the machine with an air filtration device having a relatively shorter projected service life, thereby possibly reducing the cost associated with the air filtration device.

Therefore, it may be desirable to provide an air filtration device for machines that can be selectively or alternatively configured to achieve different filtration characteristics. In addition, it may be desirable to provide filter elements having different filtration characteristics and that are able to be installed in the same air cleaner housing.

An example of a filter housing assembly for a vehicle is described in U.S. Pat. No. 6,692,347 B1 to Schneider (“the '347 patent”). According to the '347 patent, a filter housing assembly is provided that inhibits the ingestion of foreign matter and particulates into an air intake of a motor vehicle. The filter housing assembly includes a filter housing member adapted to house a filter, which may be integrated within the assembly as an integral manufactured component in sealable engagement, or a modular engageable assembly, which allows the selected filter to be removed and replaced at will to ensure that the air intake portions of the vehicle are free from debris and unwanted foreign matter.

Although the '347 patent purports to provide an effective air filtration system, it does not permit the selective or alternative use of different filters configured to achieve different filtration characteristics. The air cleaner assembly and filter element disclosed herein may be directed to mitigating or overcoming one or more of the possible drawbacks set forth above.

### SUMMARY

According to a first aspect, the present disclosure is directed to a filter element for an air cleaner assembly. The filter element may include a first side member and a second side member opposite the first side member. The first and second side members may extend in a substantially longitudinal direction and substantially within respective first and second planes with an intermediate space therebetween. The filter element may further include filter media separating and extending between the first side member and the second side member in the intermediate space. The first and second side members and the filter media may have a perimeter cross-section substantially perpendicular to the longitudinal direction, and the filter element may further include a locating flange extending substantially around the perimeter cross-section and transverse to the longitudinal direction, wherein the locating flange does not lie within a single plane.

According to a further aspect, the present disclosure is directed to an air cleaner assembly. The air cleaner assembly may include an inlet housing member having an inlet port, wherein the inlet housing member includes a first internal ridge extending around an interior periphery of the inlet housing member. The air cleaner assembly may further include an outlet housing member having an outlet port configured to be coupled to an air conduit, wherein the outlet housing member includes a second internal ridge extending around an interior periphery of the outlet housing member. The air cleaner assembly may also include a filter element received in the inlet housing member and the outlet housing member, wherein the filter element includes a locating flange sandwiched between the first internal ridge and the second internal ridge upon receipt in the inlet housing member and the outlet housing member. The inlet housing member and the outlet housing member may be configured to alternatively receive a first filter element having a first projected service life and a second filter element having a second projected service life different from the first projected service life.

### BRIEF DESCRIPTION OF THE DRAWINGS

FIG. 1 is a schematic diagram of an exemplary embodiment of an internal combustion engine.

FIG. 2 is an exploded, perspective view of an exemplary embodiment of an air cleaner assembly.

FIG. 3 is a perspective view of an exemplary embodiment of an air cleaner assembly.

FIG. 4 is a perspective view of an exemplary embodiment of an inlet housing member.

FIG. 5 is a perspective view of an exemplary embodiment of a filter element.

FIG. 6 is a perspective view of an exemplary embodiment of an outlet housing member.

FIG. 7 is an exploded, perspective view of an exemplary embodiment of an air cleaner assembly.

FIG. 8 is a perspective view of an exemplary embodiment of a filter element.

### DETAILED DESCRIPTION

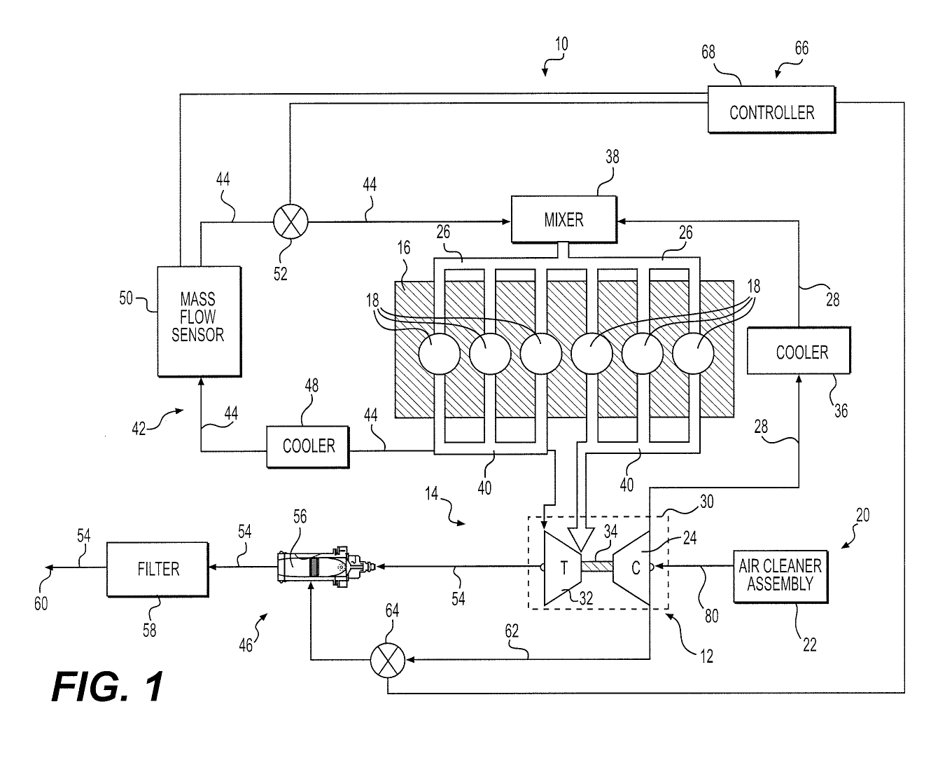

Air cleaners may be used for removing particulate matter from air entering an internal combustion engine. An exemplary embodiment of an internal combustion engine 10 is shown in FIG. 1. Engines may be used to supply power for machines, such as for example, any type of ground-borne vehicle, such as, for example, an automobile, a truck, an agricultural vehicle, and/or a construction vehicle, such as, for example, a wheel loader, a dozer, a track-type tractor, an excavator, a grader, an on-highway truck, an off-highway truck, and/or any other vehicle type known to a person skilled in the art. In addition, engines may supply power to any stationary machines, such as, for example, genset for generating electric power or a pump for pumping a fluid such as water, natural gas, or petroleum. Although engine 10 shown in FIG. 1 is a reciprocating internal combustion engine and may be, for example, a spark-ignition engine or a compression-ignition engine, other types of engines are contemplated, such as, for example, rotary engines, gas turbine engines, and/or engines powered by gasoline, diesel fuel, bio-diesel, ethanol, methanol, and combinations thereof.

As shown in FIG. 1, exemplary engine 10 includes an intake system 12 and an exhaust system 14. Exemplary engine 10 includes a cylinder block 16 at least partially defining a plurality of cylinders 18 providing combustion chambers in which an air-fuel mixture is combusted to generate power. Although exemplary engine 10 shown in FIG. 1 includes six cylinders 18 in an in-line configuration, engines having other numbers of cylinders and other configurations known in the art are contemplated.

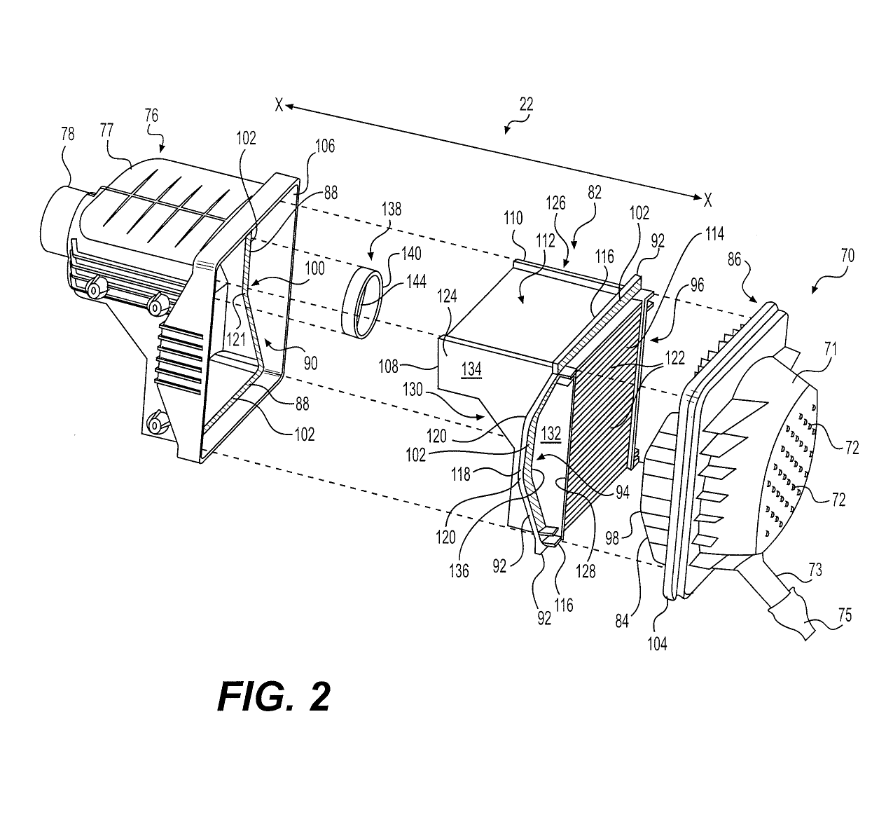

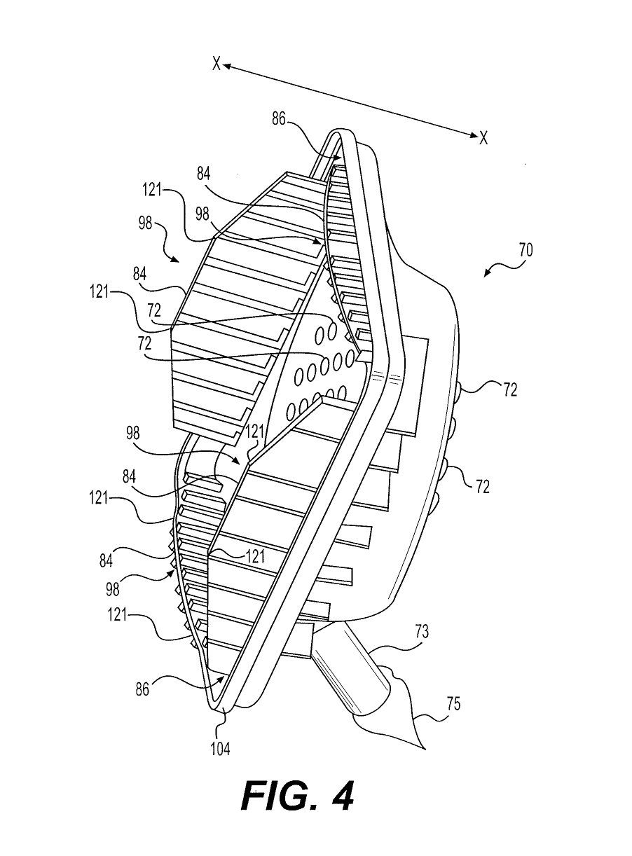

Exemplary intake system 12 shown in FIG. 1 is configured to provide air to cylinders 18 from an intake inlet 20 that provides flow communication between ambient air of the surroundings and cylinders 18. Intake system 12 includes an air cleaner assembly 22 configured to remove particulate matter from air entering intake inlet 20 from the surroundings and may include a filter device as explained in more detail with respect to FIGS. 2-8. According to some embodiments, intake inlet 20 may be part of air cleaner assembly 22. Exemplary intake system 12 also includes a compressor 24 configured to increase the pressure of air entering intake system 12 at intake inlet 20 before it reaches an intake manifold 26 providing flow communication with cylinders 18 via intake conduit 28. Exemplary compressor 24 shown in FIG. 1 is a part of a turbocharger 30 further including an exhaust-driven turbine 32. Turbine 32 is coupled via a shaft 34 to compressor 24, such that flow of exhaust gas through turbine 32 results in turbine 32 rotating shaft 34, which, in turn, drives compressor 24, thereby increasing the pressure of air in intake system 12. Although exemplary compressor 24 is a turbine-driven compressor, other types of compressors are contemplated, such as, for example, compressors driven by an output shaft of engine 10 and/or other motors (e.g., electric motors).

Exemplary intake system 12 also includes an air cooler 36 configured to cool compressed air downstream of compressor 24 before the compressed air enters intake manifold 26, resulting in a cooler, more dense, air-fuel mixture. Cooler 36 may be any type of cooler known in the art, such as, for example, an air-cooled air cooler or a liquid-cooled air cooler. Exemplary intake system 12 also includes a mixer 38 configured to combine a portion of exhaust gas re-circulated for addition to air entering exhaust manifold 26.

Exemplary exhaust system 14 is configured to provide flow communication between cylinders 18 and the ambient air of the surroundings, so that by-products of combustion in cylinders 18 can be treated and expelled to the surroundings. Exemplary exhaust system 14 shown in FIG. 1 includes an exhaust manifold 40 providing flow communication between cylinders 18 and either an exhaust gas recirculation system 42 via recirculation conduit 44 providing flow communication with mixer 38 and intake system 12, or an exhaust gas treatment system 46.

Exemplary exhaust gas recirculation system 42 is configured to permit a controlled amount of exhaust gas to be supplied to intake system 12 via mixer 38. As shown in FIG. 1, exemplary exhaust gas recirculation system 42 includes a cooler 48 downstream of exhaust manifold 40 and upstream of a mass flow sensor 50. Exemplary cooler 48 is configured to cool exhaust gas before it reaches mixer 38, which may provide benefits to the combustion process of engine 10. Cooler 48 may be any type of cooler known in the art, such as, for example, an air-cooled cooler or a liquid-cooled cooler. Mass flow sensor 50 is configured to provide signals indicative of the flow rate of exhaust gas through recirculation conduit 44 to mixer 38. Exhaust gas recirculation system 42 may further include a valve 52 configured to control the flow of exhaust gas from exhaust manifold 40 to mixer 38.

As shown in FIG. 1, exhaust gas treatment system 46 is downstream of turbine 32 of turbocharger 30 and may be configured to remove undesirable particulates from the exhaust gas and/or convert undesirable exhaust gas constituents to more desirable exhaust gas constituents, as is known in the art. Exemplary exhaust gas treatment system 46 includes an exhaust conduit 54 providing flow communication with a regeneration device 56 located downstream of turbine 32 and upstream of a particulate filter 58 (e.g., a diesel particulate filter), which, in turn, is upstream of exhaust outlet 60. Exemplary particulate filter 58 may be configured to trap undesirable particulates, so that they do not exit exhaust outlet 60, as is known in the art. Because the effectiveness of particulate filter 58 may degrade as more particulates are trapped therein, it may be desirable to regenerate the effectiveness of particulate filter 58. Exemplary regeneration device 56 may be configured to regenerate particulate filter 58 according to methods known in the art. For example, according to some embodiments, regeneration device 56 may be configured to ignite and burn-off particulates accumulated in particulate filter 58 to enhance its effectiveness.

As shown in FIG. 1, exemplary exhaust gas treatment system 46 may further include a bypass conduit 62 providing flow communication between compressor 24 and regeneration device 56. In the exemplary embodiment shown, a bypass valve 64 may be located between compressor 24 and regeneration device 56 to control flow communication therebetween. Bypass valve 64 may be located at other locations intake system 12, such as any location between compressor 24 and cylinders 18. According to some embodiments, bypass valve 64 may be opened to supply air to regeneration device 56, thereby supplying air for ignition and combustion of particulates in particulate filter 58. In addition, bypass valve 64 may be configured to bleed pressure created by operation of compressor 24. According to some embodiments, pressure may be bled to the surroundings and/or to a location of intake system 12 upstream from compressor 24.

As shown in FIG. 1, exemplary engine 10 also includes a control system 66 configured to control operation of engine 10, intake system 12, and/or exhaust system 14. For example, exemplary control system 66 shown in FIG. 1 includes a controller 68 configured to receive signals from various sensors associated with engine 10 and, based one or more of the signals, control operation of engine 10. Exemplary controller 68 may include one or more processors, microprocessors, central processing units, on-board computers, electronic control modules, and/or any other computing and control devices known to those skilled in the art. Controller 68 may be configured run one or more software programs or applications stored in a memory location, read from a computer-readable medium, and/or accessed from an external device operatively coupled to controller 68 by any suitable communications network.

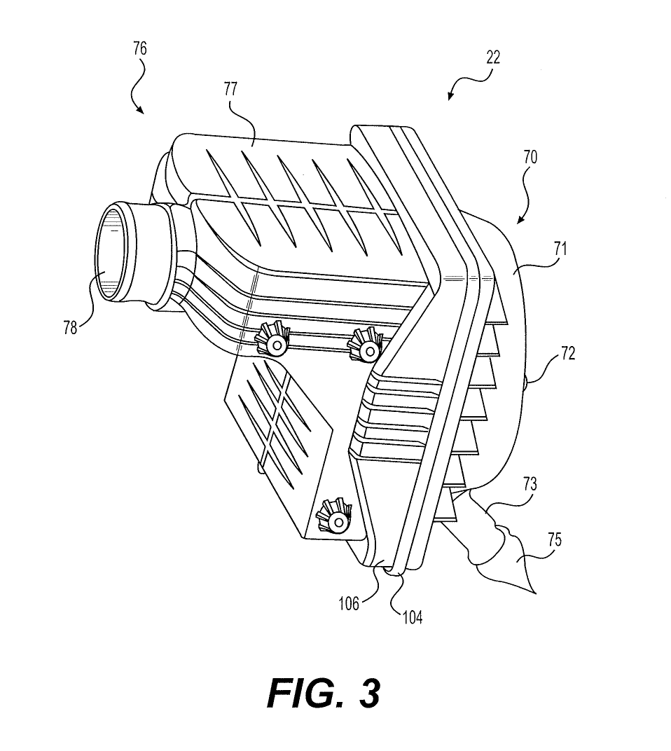

FIGS. 2 and 3 show an exemplary embodiment of an air cleaner assembly 22 configured to remove particulate matter from air entering an internal combustion engine. As shown in FIG. 2, exemplary air cleaner assembly 22 includes an inlet housing member 70 having a plurality inlet ports 72 providing an intake inlet 20 (see, e.g., FIG. 1) of an internal combustion engine, such as exemplary engine 10. Air entering inlet ports 72 may be drawn-in from exterior to the engine and used for combustion in the engine.

Exemplary air cleaner assembly 22 shown in FIGS. 2 and 3 also includes an outlet housing member 76 (see FIG. 6) having an outer shell 77 and an outlet port 78 configured to be coupled to an air conduit 80. For example, as shown in FIG. 1, air conduit 80 is located upstream of compressor 24 of turbocharger 30. According to some embodiments, the engine on which air cleaner assembly 22 is installed may not have a compressor or turbocharger.

Exemplary air cleaner assembly 22 shown in FIG. 2 also includes a filter element 82 received in inlet housing member 70 and outlet housing member 76, with filter element 82, inlet housing member 70, and outlet housing member 76 being configured such that air entering inlet ports 72 and exiting outlet port 78 is forced to pass through filter element 82, thereby removing particulate matter from air entering the engine. For example, being drawn-in from the surroundings, the air may contain particulates, such as dust and dirt, particularly if the engine is being operated in dusty environments, such as a construction or mining worksite. Thus, air cleaner assembly 22 may be used to remove at least some of the particulate matter to prevent premature wear or damage to the engine.

In the exemplary embodiment shown in FIGS. 2-4, inlet housing member 70 includes an outer shell 71 including inlet ports 72. According to some embodiments, inlet ports 72 include cyclone-tube, pre-cleaners configured to cause air entering inlet ports 72 to spin and thereby eject relatively large particles from air entering inlet ports 72. For example, one or more air-directing fins (e.g., several stationary blades, not shown) may cause the air to spin and eject relatively larger particles from the air as in enters inlet housing member 70. In the exemplary embodiment shown, inlet housing member 70 also includes a collection pipe 73 into which the relatively larger particles may fall for collection and removal. According to some embodiments, inlet housing member 70 may also include a valve 75 (e.g., a rubber valve) for removing collected particles from collection pipe 73. Once air passes through inlet ports 72, it enters the interior of inlet housing member 70.

According to some embodiments, inlet housing member 70 may be coupled to outlet housing member 76 via fasteners (not shown), such as, for example, screws, bolts, and/or latches. Thus, inlet housing member 70 may be selectively and removably secured to outlet housing member 76.

Exemplary inlet housing member 70 shown in, for example, FIGS. 2-4, includes an internal ridge 84 extending around an interior periphery 86 of inlet housing member 70. Similarly, exemplary outlet housing member 76 shown in, for example, FIGS. 2, 3, and 6, includes an internal ridge 88 extending around an interior periphery 90 of outlet housing member 76. Exemplary filter element 82 includes a locating flange 92 that, when assembled, is sandwiched between internal ridge 84 of inlet housing member 70 and internal ridge 88 of outlet housing member 76 upon receipt in inlet housing member 70 and outlet housing member 76. For example, as shown in FIG. 2, exemplary locating flange 92 has a flange profile 94 extending along the length of locating flange 92 as it extends around a perimeter cross-section 96 of filter element 82, with perimeter cross-section 96 being substantially perpendicular to a longitudinal direction X of air cleaner assembly 22. Internal ridge 84 of inlet housing member 70 has a ridge profile 98 that substantially corresponds to flange profile 94 of filter element 82, and similarly, internal ridge 88 of outlet housing member 76 has a ridge profile 100 that substantially corresponds to flange profile 94.

According to some embodiments, one or more of locating flange 92, internal ridge 84, and internal ridge 88 includes a sealing member 102 configured to provide a substantially air-tight seal between locating flange 92 and least one of internal ridge 84 and internal ridge 88. Sealing member 102 may include any type of material that provides such a seal, such as, for example, gasket material, a bead of silicone or polymer, or other similar material. For example, sealing member 102 may be provided on one or more sides of locating flange 92 of filter element 82.

In the exemplary embodiment shown in FIG. 2, locating flange 92, internal ridge 84, and internal ridge 88 do not lie substantially within a single plane. Rather, flange profile 94, ridge profile 98, and ridge profile 100 follow a serpentine path. This exemplary configuration may serve to ensure that filter element 82 is received in inlet housing member 70 and outlet housing member 76 in the correct orientation when installed. In addition, this may serve to ensure that a filter element intended for use with air cleaner assembly 22, as compared to other filter elements not intended for use with air cleaner assembly 22, is installed in air cleaner assembly 22.

For example, exemplary air cleaner assembly 22 may be configured to receive filter elements having different filtration characteristics, with the different filter elements having common locating flange configurations that correspond to respective ridge profiles 98 and 100 of inlet housing member 70 and outlet housing member 76. For example, air cleaner assembly 22 may be configured to alternatively receive a first filter element having a first projected service life characteristic, as well as a second filter element having a second projected service life characteristic that differs from the first projected service life characteristic. For example, the first filter element may have a projected service life, dependent on a number of factors, such as, for example, operating environment, of about 500 hours of operation before cleaning or replacement is advisable. In contrast, the second filter element may have a projected service life of about 250 hours of operation before cleaning or replacement is advisable. However, the first and second filter elements may have a commonly configured locating flange, so that either the first filter element or the second filter element may be installed in inlet housing member 70 and outlet housing member 76. Filter elements having other projected service lives are contemplated. According to some embodiments, filter elements having a commonly configured locating flange may have different exterior dimensions that may relate, for example, to the projected service life of the respective filter element. For example, a first filter element may have a relatively larger exterior dimension than the corresponding exterior dimension of a second filter element. The relatively larger exterior dimension may correlate to having a relatively longer projected service life.

As shown in FIGS. 2-4, exemplary inlet housing member 70 includes an exterior flange 104, and outlet housing member 76 includes a peripheral edge 106. Peripheral edge 106 is configured to be received in exterior flange 104 of inlet housing member 70 when inlet housing member 70 and outlet housing member 76 are engaged with one another (e.g., see FIG. 3). According to some embodiments, outlet housing member 76 includes an exterior flange, and inlet housing member 70 includes a peripheral edge, with the peripheral edge being configured to be received in the exterior flange of outlet housing member 76 when inlet housing member 70 and outlet housing member 76 are engaged with one another. According to some embodiments, a seal member (not shown) may be associated with one or more of exterior flange 104 and peripheral edge 106 in order to provide a substantially air-tight seal between inlet housing member 70 and outlet housing member 76. This exemplary configuration may serve to further seal filter element 82 within air cleaner assembly 22.

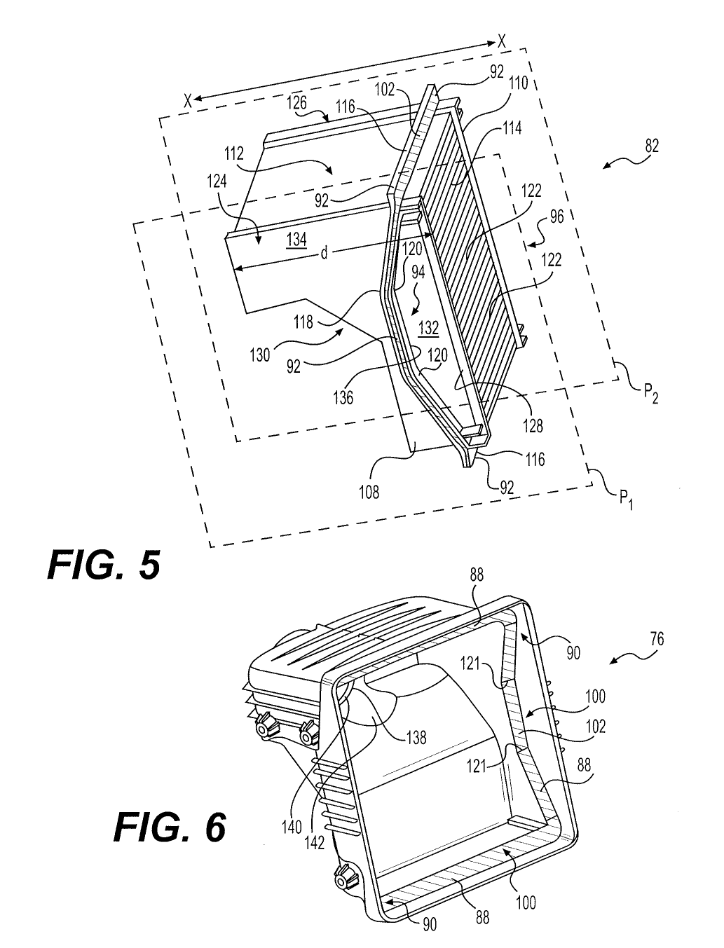

FIG. 5 shows an exemplary embodiment of filter element 82. As shown, exemplary filter element 82 includes a first side member 108 and a second side member 110 opposite first side member 108. Exemplary side members 108 and 110 extend substantially in a longitudinal direction X and substantially within a first plane P₁ and a second plane P₂, respectively, with an intermediate space 112 between first plane P₁ and second plane P₂. According to some embodiments, first plane P₁ and second plane P₂ are substantially parallel to one another and substantially parallel to longitudinal direction X. Exemplary filter element 82 shown in FIG. 5 also includes filter media 114 separating and extending between first side member 108 and second side member 110 in intermediate space 112. As shown, first and second side members 108 and 110 and filter media 114 have a perimeter cross-section 96 substantially perpendicular to longitudinal direction X, and exemplary filter element 82 also includes locating flange 92 extending substantially around perimeter cross-section 96 and transverse to longitudinal direction X. For example, locating flange 92 may extend in a direction substantially perpendicular to longitudinal direction X as it extends around perimeter cross-section 96. According to some embodiments, locating flange 92 may extend around perimeter cross-section 96 in a substantially uninterrupted manner, for example, as shown in FIG. 5. According to some embodiments, locating flange 92 may extend around perimeter cross-section 96 in an interrupted manner, for example, such that locating flange 92 has gaps and/or apertures therein.

In the exemplary embodiment shown in FIG. 5, locating flange 92 is configured such that it does not lie within a single plane. For example, locating flange 92 includes two opposing transverse segments 116 extending between first and second side members 108 and 110, and transverse segments 116 may lie in a common plane, for example, as shown in FIG. 5, that is substantially perpendicular to the longitudinal direction X. Exemplary locating flange 92 also includes two opposing side segments 118 that couple opposing ends of transverse segments 116 to one another. Exemplary side segments 118 do not lie in a single plane. Rather, side segments 116 include bends 120 between respective ends of opposing transverse segments 116. Bends 120 of side segments 116 may substantially correspond to bends 121 of internal ridge 84 of inlet housing member 70 and internal ridge 88 of outlet housing member 76.

Exemplary locating flange 92 of filter element 82 shown in FIG. 5 is configured to be sandwiched between opposing portions of inlet housing member 70 and outlet housing member 76 when air cleaner assembly 22 is assembled. For example, locating flange 92 is configured to be sandwiched between opposing internal ridge 84 of inlet housing member 70 and internal ridge 88 of outlet housing member 76. According to some embodiments, locating flange 92 is configured to be clamped or squeezed between opposing internal ridge 84 inlet housing member 70 and internal ridge 88 of outlet housing member 76 in order to provide a substantially air-tight seal. For example, one or more side faces of locating flange 92 may include sealing member 102 configured to provide a substantially air-tight seal when filter element 82 is assembled in air cleaner assembly 22.

In the exemplary embodiment shown in FIG. 5, filter media 114 of filter element 82 includes pleated paper having folds 122 extending between first side member 108 and second side member 110. For example, folds 122 may extend in a direction transverse with respect to (e.g., substantially perpendicular with respect to) longitudinal direction X and transverse with respect to (e.g., substantially perpendicular with respect to) first side member 108 and second side member 110. According to some embodiments, filter media 114, configured and arranged in the exemplary manner shown in FIG. 5 may result in a relatively more laminar flow of air exiting exemplary air cleaner assembly 22 via outlet port 78, as compared to traditional, circular air cleaners. A more laminar air flow may result in, for example, more efficient and/or improved performance from a compressor of a turbocharger or supercharger in engines having such features. According to some embodiments, a more laminar air flow may effectively increase the service life the filter element due, for example, to a more accurate reading from a service life indicator, such as, for example, a sensor configured to indicate a pressure differential across filter element 82.

According to the exemplary embodiment shown in FIG. 5, first and second side members 108 and 110 of filter element 82 include a first face 124 and a second face 126, respectively. First and second faces 124 and 126 may be substantially perpendicular to longitudinal direction X, and first and second faces 124 and 126 may each have a first edge 128 extending substantially perpendicular to longitudinal direction X and in respective first and second planes P₁ and P₂, as shown in FIG. 5. First and second faces 124 and 126 may extend from respective first edges 128 to respective second edges 130 opposite first edges 128, such that a distance din a direction parallel to longitudinal direction X between respective first and second edges 128 of respective first side member 108 and second side member 110 differs, for example, with respect to a direction substantially parallel with first side edges 128, as shown in FIG. 5. For example, first and second faces 124 and 126 are not necessarily rectangular.

According to some embodiments, filter media 114 has a cross-section viewed perpendicular to longitudinal direction X that is substantially the same shape as at least one of first face 124 and second face 126. For example, filter media 114 may have a cross-section that is substantially co-extensive with the shape of first face 124 and/or second face 126.

According to the exemplary filter element 82 shown in FIG. 5, first and second faces 124 and 126 are substantially L-shaped, in particular, an inverted L-shape in the orientation shown. In this exemplary configuration, locating flange 92 extends across first face 124 and second face 126 at a location intermediate respective first and second edges 128 and 130 of respective first and second faces 24 and 126 relative to longitudinal direction X. For example, respective first and second faces 124 and 126 include respective first portions 132 and second portions 134, wherein respective first portions 132 include respective first edges 128 and are substantially trapezoidal, for example, as shown in FIG. 5. Exemplary locating flange 92 is substantially co-extensive with an edge 136 of respective first portions 132 opposite respective first edges 128 of respective first and second faces 124 and 126. As shown, respective second portions 134 of first and second faces 124 and 126 are substantially L-shaped, in particular, an inverted L-shape in the orientation shown.

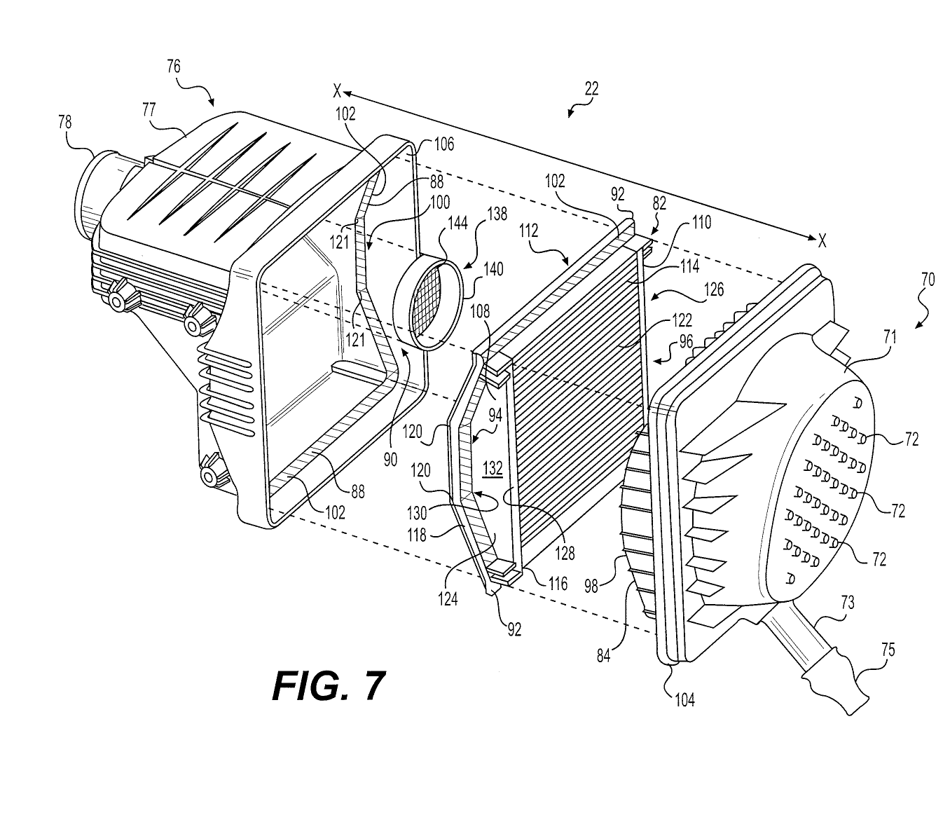

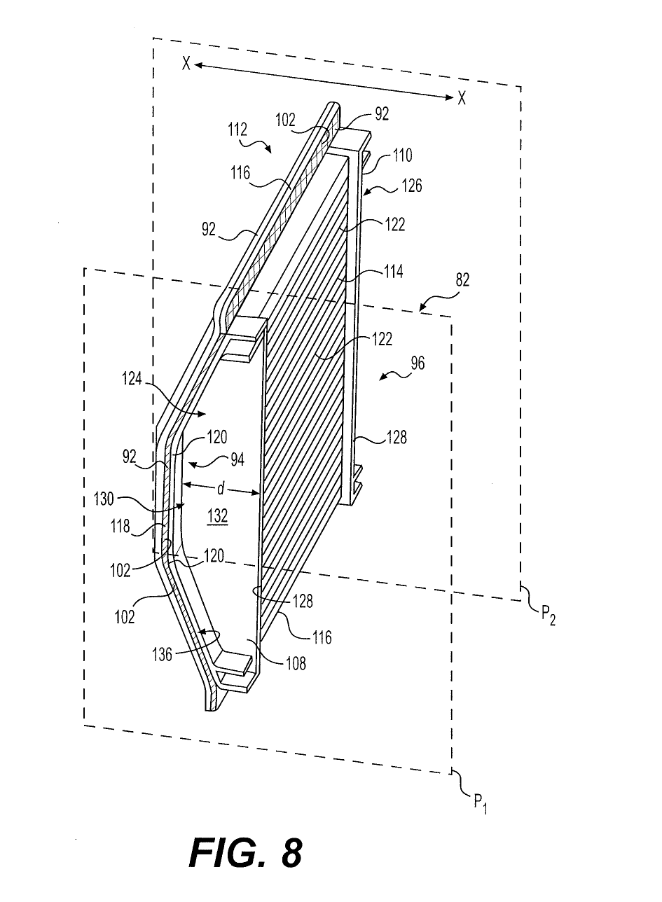

As shown in FIG. 7, air cleaner assembly 22 may include an alternative filter element 82, which may have a number of characteristics that are different than the corresponding characteristics of exemplary filter element 82 shown in FIGS. 2 and 5. However, inlet and outlet housing members 70 and 76 shown in FIG. 7 may be substantially the same (e.g., identical), while still maintaining an ability to alternatively receive exemplary filter element 82 shown in FIGS. 2 and 5, or exemplary filter element 82 shown in FIGS. 7 and 8.

In addition, exemplary filter element 82 shown in FIGS. 7 and 8 may share a number of characteristics with exemplary filter element 82 show in FIGS. 2 and 5. For example, as shown in FIG. 8, exemplary filter element 82 includes a first side member 108 and a second side member 110 opposite first side member 108. Exemplary side members 108 and 110 extend substantially in a longitudinal direction X and substantially within a first plane P₁ and a second plane P₂, respectively, with an intermediate space 112 between first plane P₁ and second plane P₂. According to some embodiments, first plane P₁ and second plane P₂ are substantially parallel to one another and substantially parallel to longitudinal direction X. Exemplary filter element 82 shown in FIG. 8 also includes filter media 114 separating and extending between first side member 108 and second side member 110 in intermediate space 112. As shown, first and second side members 108 and 110 and filter media 114 have a perimeter cross-section 96 substantially perpendicular to longitudinal direction X, and exemplary filter element 82 also includes locating flange 92 extending substantially around perimeter cross-section 96 and transverse to longitudinal direction X. For example, locating flange 92 may extend in a direction substantially perpendicular to longitudinal direction X as it extends around perimeter cross-section 96. Exemplary locating flange 92 extends around perimeter cross-section 96 in a substantially uninterrupted manner. According to some embodiments, locating flange 92 may extend around perimeter cross-section 96 in an interrupted manner, for example, such that locating flange 92 has gaps and/or apertures therein.

In the exemplary embodiment shown in FIG. 8, locating flange 92 is configured such that it does not lie within a single plane. For example, as shown in FIG. 8, locating flange 92 includes two opposing transverse segments 116 extending between first and second side members 108 and 110, and transverse segments 116 may lie in a common plane that is substantially perpendicular to the longitudinal direction X. Exemplary locating flange 92 also includes two opposing side segments 118 that couple opposing ends of transverse segments 116 to one another. Exemplary side segments 118 do not lie in a single plane. Rather, side segments 116 include bends 120 between respective ends of opposing transverse segments 116. Bends 120 of side segments 116 may substantially correspond to bends 121 of internal ridge 84 of inlet housing member 70 and internal ridge 88 of outlet housing member 76, as shown in FIG. 7.

Exemplary locating flange 92 of filter element 82 shown in FIG. 8 is configured to be sandwiched between opposing portions of inlet housing member 70 and outlet housing member 76 when air cleaner assembly 22 is assembled, as shown in FIG. 7, which shows locating flange 92 is configured to be sandwiched between opposing internal ridge 84 of inlet housing member 70 and internal ridge 88 of outlet housing member 76. According to some embodiments, locating flange 92 is configured to be clamped or squeezed between opposing internal ridge 84 inlet housing member 70 and internal ridge 88 of outlet housing member 76 in order to provide a substantially air-tight seal. For example, one or more side faces of locating flange 92 may include sealing member 102 configured to provide a substantially air-tight seal when filter element 82 is assembled in air cleaner assembly 22.

In the exemplary embodiment shown in FIG. 7, filter media 114 of filter element 82 includes pleated paper having folds 122 extending between first side member 108 and second side member 110. Exemplary folds 122 extend in a direction transverse with respect to (e.g., substantially perpendicular with respect to) longitudinal direction X and transverse with respect to (e.g., substantially perpendicular with respect to) first side member 108 and second side member 110. According to some embodiments, filter media 114 configured and arranged in the exemplary manner shown in FIG. 8 may result in a relatively more laminar flow of air exiting exemplary air cleaner assembly 22 via outlet port 78, as compared to traditional, circular air cleaners.

According to the exemplary embodiment shown in FIG. 8, first and second side members 108 and 110 of filter element 82 include a first face 124 and a second face 126, respectively. First and second faces 124 and 126 may be substantially perpendicular to longitudinal direction X, and first and second faces 124 and 126 may each have a first edge 128 extending substantially perpendicular to longitudinal direction X and in respective first and second planes P₁ and P₂, as shown in FIG. 8. First and second faces 124 and 126 may extend from respective first edges 128 to respective second edges 130 opposite first edges 128, such that a distance d in a direction parallel to longitudinal direction X between respective first and second edges 128 of respective first side member 108 and second side member 110 differs, for example, with respect to a direction substantially parallel with first side edges 128, as shown in FIG. 8. For example, first and second faces 124 and 126 are not necessarily rectangular.

According to some embodiments, filter media 114 has a cross-section viewed perpendicular to longitudinal direction X that is substantially the same shape as at least one of first face 124 and second face 126. For example, filter media 114 may have a cross-section that is substantially co-extensive with the shape of first face 124 and/or second face 126.

Exemplary filter element 82 shown in FIGS. 7 and 8 has at least one different exterior dimension, as compared to exemplary filter element 82 shown in FIGS. 2 and 5. For example, distance d between first edge 128 and second edge 130 is greater in the exemplary filter element 82 shown in FIGS. 2 and 5, as compared to the corresponding distance d of the exemplary embodiment of filter element 82 shown in FIGS. 7 and 8. As shown in FIGS. 2 and 7, exemplary inlet housing member 70 and exemplary outlet housing member 76 are configured to accommodate either the exemplary filter element 82 shown in FIGS. 2 and 5, or the exemplary filter element 82 shown in FIGS. 7 and 8. Thus, while inlet housing members 70 and outlet housing members 76 shown in FIGS. 2 and 7 may be substantially the same (e.g., exactly the same), exemplary filter element 82 shown in FIGS. 7 and 8 may differ in a number of ways from exemplary filter element 82 shown in FIGS. 2 and 5.

For example, for exemplary filter element 82 shown in FIGS. 7 and 8, first and second faces 124 and 126 are substantially trapezoidal, and locating flange 92 is substantially co-extensive with second edge 130 of first face 124 and second edge 130 of second face 126. Thus, exemplary filter element 82 shown in FIGS. 7 and 8 does not include respective second portions 134 of first and second faces 124 and 126, or any corresponding filter media therebetween, which is characteristic of filter element 82 shown in FIGS. 2 and 5.

The differences between exemplary filter element 82 shown in FIG. 5 and exemplary filter element 82 shown in FIG. 8 may correlate to different filtration characteristics, such as, for example, different filtration capacities (e.g., the maximum air flow rate at which filter element 82 may filter air), effectiveness for capturing particulates larger than a predetermined size, and projected service life. For example, exemplary filter element 82 shown in FIGS. 2 and 5 may have a higher filtration volume than exemplary filter element 82 shown in FIGS. 7 and 8. According to some embodiments, exemplary filter element 82 shown in FIGS. 2 and 5 may be able to capture particles having a smaller maximum size than exemplary filter element 82 shown in FIGS. 7 and 8. According to some embodiments, exemplary filter element 82 shown in FIGS. 2 and 5 may have a longer projected service life than exemplary filter element 82 shown in FIGS. 7 and 8. For example, exemplary filter element 82 shown in FIGS. 2 and 5 may have a projected service life of about 500 hours, while exemplary filter element 82 shown in FIGS. 7 and 8 may have a projected service life of about 250 hours. Projected service lives of different duration are contemplated.

As shown in FIGS. 2, 6, and 7, air cleaner assembly 22 may include a safety filter 138 configured to prevent relatively large particulates from entering the engine, for example, if filter element 82 is either not present in air cleaner assembly 22, or is damaged such that it permits the unfiltered flow of air past filter media 114. According to some embodiments, safety filter 138 includes a retaining ring 140 configured to fit snugly within a recess 142 (see FIG. 6) associated with the upstream entry to outlet port 78 of outlet housing member 76. A mesh member 144 may be coupled to retaining ring 140, such that air passing through retaining ring 140 into outlet port 78 passes through mesh member 144, which prevents the exit of relatively large particulates from outlet port 78 into the engine. The relative fineness of the mesh of mesh member 144 may be selected to prevent particulates having larger than a desired maximum size from passing through safety filter 138. According to some embodiments, mesh member 144 may be supplemented by (or replaced with) a pleated filter media, for example, fitted in a cylindrical inner volume of safety filter 138. According to some embodiments, mesh member 144 may be selected to provide structural support rather than (or in addition to) filtration (e.g., mesh member 44 may be formed from a rigid material, such as, for example, metal).

### INDUSTRIAL APPLICABILITY

The filter elements and air cleaner assemblies disclosed herein may be used to remove particulates from air entering a machine that relies on air flow for operation. For example, internal combustion engines combine air and fuel for combustion to develop power that may be used to perform work, such as propelling a vehicle and/or operating other devices associated with the vehicle. The air filters and air cleaner assemblies may be used to prevent entry of particulates into the internal combustion engine to reduce or prevent contamination of the oil and other parts of the engine that may lead to premature wear or damage to parts of the internal combustion engine.

According to some embodiments, air filter 82 and air cleaner assembly 22 may be used to selectively or alternatively provide air cleaner assemblies having different filtration characteristics, such as, for example, different filtration capacities, different levels of effectiveness for capturing particulates larger than a predetermined size, and different projected service lives, depending on circumstances associated with operation of the machine on which the air cleaner assembly is installed. For example, when a machine has been purchased and operated by a first owner, it may be anticipated that it will be operated on a regular basis and for an extended period of time. It may be desirable under such circumstances to provide the machine with a filter element having a relatively long projected service life, which may result in less maintenance time associated with servicing the air cleaner assembly. In contrast, a subsequent purchaser of the previously owned machine may not anticipate using the machine on as consistent a basis as the previous owner. Under such circumstances, it may be desirable to provide the machine with a filter element having a relatively shorter projected service life, thereby possibly reducing costs associated with the air cleaner assembly.

In addition, according to embodiments having filter media including pleated paper, such embodiments may result in a relatively more laminar flow of air exiting the air cleaner assembly via the outlet port, as compared to other air cleaner assemblies. A more laminar air flow may result in, for example, more efficient and/or improved performance from a compressor of a turbocharger or supercharger in engines having such features.

It will be apparent to those skilled in the art that various modifications and variations can be made to the exemplary disclosed filter elements and air cleaner assemblies. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A filter element for an air cleaner assembly, the filter element comprising:
a first side member;
a second side member opposite the first side member, wherein the first and second side members extend in a substantially longitudinal direction and substantially within respective first and second planes with an intermediate space therebetween;
filter media separating and extending between the first side member and the second side member in the intermediate space, the first and second side members and the filter media having a perimeter cross-section substantially perpendicular to the longitudinal direction; and
a locating flange extending substantially around the perimeter cross-section and transverse to the longitudinal direction,
wherein the locating flange does not lie within a single plane.

2. The filter element of claim 1, wherein the locating flange is configured to be sandwiched between opposing portions of two housing members.

3. The filter element of claim 1, further including a sealing member associated with the locating flange, the sealing member being configured to provide a substantially air-tight seal when the filter element is assembled in an air cleaner assembly.

4. The filter element of claim 1, wherein the filter media includes pleated paper having folds extending between the first side member and the second side member.

5. The filter element of claim 1, wherein the first and second side members include respective first and second faces substantially perpendicular to the longitudinal direction, wherein the first and second faces each have a first edge extending substantially perpendicular to the longitudinal direction and in the respective first and second planes, and wherein the first and second faces extend from the first edge to respective second edges opposite the respective first edges, such that the distance in the longitudinal direction between the respective first edge and second edge of the respective first side member and second side member differs.

6. The filter element of claim 5, wherein the filter media has a cross-section perpendicular to the longitudinal direction and perpendicular to the perimeter cross-section that is substantially the same shape as at least one of the first face and the second face.

7. The filter element of claim 5, wherein the first and second faces are substantially trapezoidal.

8. The filter element of claim 5, wherein the locating flange is substantially co-extensive with the second edge of the first face and the second edge of the second face.

9. The filter element of claim 5, wherein the first and second faces are substantially L-shaped.

10. The filter element of claim 9, wherein the locating flange extends across the first face and the second face at a location intermediate the respective first and second edges of the respective first and second faces relative to the longitudinal direction.

11. The filter element of claim 10, wherein the respective first and second faces include respective first portions and second portions, wherein the respective first portions include the respective first edges and are substantially trapezoidal.

12. The filter element of claim 11, wherein the locating flange is substantially co-extensive with an edge of the respective first portions opposite the respective first edges of the respective first and second faces.

13. The filter element of claim 11, wherein the respective second portions of the first and second faces are substantially L-shaped.

14. The filter element of claim 1, wherein the respective first and second planes of the first and second side members are substantially parallel.

15. An air cleaner assembly comprising:
an inlet housing member having an inlet port, wherein the inlet housing member includes a first internal ridge extending around an interior periphery of the inlet housing member;
an outlet housing member having an outlet port configured to be coupled to an air conduit, wherein the outlet housing member includes a second internal ridge extending around an interior periphery of the outlet housing member; and
a filter element received in the inlet housing member and the outlet housing member, wherein the filter element includes a locating flange sandwiched between the first internal ridge and the second internal ridge upon receipt in the inlet housing member and the outlet housing member,
wherein the inlet housing member and the outlet housing member are configured to alternatively receive a first filter element having a first projected service life and a second filter element having a second projected service life different from the first projected service life.

16. The air cleaner assembly of claim 15, wherein the first filter element has a first exterior dimension and the second filter element has a second exterior dimension larger than the first exterior dimension.

17. The air cleaner assembly of claim 15, wherein the locating flange has a flange profile extending along its length, and wherein the first internal ridge and the second internal ridge have respective first and second ridge profiles that correspond to the flange profile.

18. The air cleaner assembly of claim 17, wherein the locating flange does not lie substantially within a single plane.

19. The air cleaner assembly of claim 17, wherein at least one of the locating flange, the first internal ridge, and the second internal ridge includes a sealing member configured to provide a substantially air-tight seal between locating flange and at least one of the first internal ridge and the second internal ridge.

20. The air cleaner assembly of claim 14, wherein at least one of the inlet housing member and the outlet housing member includes an exterior flange, and the other of the inlet housing member and the outlet housing member includes a peripheral edge, and wherein the peripheral edge is received in the exterior flange.
